(19) United States
(12) Patent Application Publication
(10) Pub. No.: US 2026/0331408 A1
(43) Pub. Date: Oct. 22, 2026

(54) CONDUCTIVE MODULE

(71) Applicant: YAZAKI CORPORATION, Tokyo (JP)

(72) Inventors: Mariko Nakagawa, Makinohara-shi (JP); Katsunori Sato, Makinohara-shi (JP); Yasuhiro Kominato, Makinohara-shi (JP)

(21) Appl. No.: 19/648,691

(22) Filed: Apr. 15, 2026

(30) Foreign Application Priority Data
Apr. 17, 2025 (JP) 2025-067973

(51) Int. Cl. H01H 85/055; H01H 85/143; H01M 50/583; H01H 85/02

(52) U.S. Cl. CPC H01H 85/055; H01H 85/143; H01M 50/583; H01H 2085/025; H01M 2200/103

(57) ABSTRACT

An accommodation component includes a pair of standing walls that protrude from an installation surface of a fuse unit with a gap therebetween as a part thereof and allow a first electrical connection portion of a first terminal fitting, a second electrical connection portion of a second terminal fitting, a circuit protection component, and a coating resin portion to be disposed in the gap, and the coating resin portion is in close contact with the installation surface (81) and facing wall surfaces of the pair of standing walls, and is formed between one standing wall and the other standing wall.

### CROSS-REFERENCE TO RELATED APPLICATION(S)

The present application claims priority to and incorporates by reference the entire contents of Japanese Patent Application No. 2025-067973 filed in Japan on Apr. 17, 2025.

### BACKGROUND OF THE INVENTION

### 1. Field of the Invention

The present invention relates to a conductive module.

### 2. Description of the Related Art

In a battery module in which a plurality of battery cells are arranged, a conductive module electrically connects the plurality of battery cells by using a plurality of connection conductors. The conductive module electrically connects each connection conductor to a battery monitoring unit that monitors a battery state of the battery cell by using a wiring component such as an electric wire. In this conductive module, a combination of a pair of a connection conductor and a conductor portion of a wiring component is provided for each connection conductor, and a circuit protection component such as a fuse is interposed between the connection conductor and the conductor portion of the wiring component in each combination. For example, Japanese Patent Application Laid-open No. 2024-173941 and Japanese Patent Application Laid-open No. 2018-97988 below disclose this type of conductive module.

The conductive module in Japanese Patent Application Laid-open No. 2024-173941 is provided with a fuse unit including a terminal fitting on the connection conductor side, a terminal fitting on the wiring component side, and a chip fuse between the terminal fittings. The fuse unit is provided with a frame body (resin portion) made of synthetic resin that exposes the chip fuse in the frame, and a coating resin portion (sealing portion) made of synthetic resin that is obtained by filling the frame with, for example, a liquid potting material and curing the potting material. The fuse unit is accommodated in a case member. As described above, in the conductive module in Japanese Patent Application Laid-open No. 2024-173941, the frame body that holds, for example, a liquid potting material until the potting material is cured is required separately from the case member. On the other hand, the conductive module in Japanese Patent Application Laid-open No. 2018-97988 includes a fuse (a fusible portion of a terminal fitting) and a coating resin portion (a mold resin member) formed by injection molding such as insert molding on a case member, but when the coating resin portion is made of a liquid potting material, fluidity of the liquid potting material is a problem.

### SUMMARY OF THE INVENTION

Therefore, an object of the present invention is to provide a conductive module in which a coating resin portion is inexpensively shaped with a liquid potting material.

A conductive module according to one aspect of the present invention includes a connection conductor that is directly electrically connected to an electrode terminal of a battery cell configuring a battery module; a fuse unit that indirectly electrically connects the connection conductor to a battery monitoring unit that monitors a battery state of the battery cell; and an accommodation component that is assembled to the battery module and in which the connection conductor and the fuse unit are accommodated, wherein the fuse unit includes a circuit protection component that fuses a fusible portion when an overcurrent flows between the connection conductor and the battery monitoring unit, a first terminal fitting that directly electrically connects a first electrical connection portion to a first electrode of the circuit protection component, and directly or indirectly electrically connects a conductor connection portion to the connection conductor, a second terminal fitting that directly electrically connects a second electrical connection portion to a second electrode of the circuit protection component and indirectly electrically connects the second electrical connection portion to the battery monitoring unit, a wiring component including a conductor portion having one end directly electrically connected to the second terminal fitting and the other end electrically connected indirectly to the battery monitoring unit, and a coating resin portion that is a cured body of a liquid potting material and encloses the first electrical connection portion, the second electrical connection portion, and the circuit protection component, the accommodation component includes a pair of standing walls that protrude from an installation surface of the fuse unit with a gap therebetween as a part of the accommodation component and allow the first electrical connection portion, the second electrical connection portion, the circuit protection component, and the coating resin portion to be disposed in the gap, and the coating resin portion is in close contact with the installation surface and facing wall surfaces of the pair of standing walls, and is formed between one standing wall and the other standing wall.

A conductive module according to another aspect of the present invention includes a connection conductor that is directly electrically connected to an electrode terminal of a battery cell configuring a battery module; a fuse unit that indirectly electrically connects the connection conductor to a battery monitoring unit that monitors a battery state of the battery cell; and an accommodation component that is assembled to the battery module and in which the connection conductor and the fuse unit are accommodated, wherein the fuse unit includes a circuit protection component that fuses a fusible portion when an overcurrent flows between the connection conductor and the battery monitoring unit, a first terminal fitting that directly electrically connects a first electrical connection portion to a first electrode of the circuit protection component, and directly or indirectly electrically connects a conductor connection portion to the connection conductor, a second terminal fitting that directly electrically connects a second electrical connection portion to a second electrode of the circuit protection component and indirectly electrically connects the second electrical connection portion to the battery monitoring unit, a wiring component including a conductor portion having one end directly electrically connected to the second terminal fitting and the other end electrically connected indirectly to the battery monitoring unit, and a coating resin portion that is a cured body of a liquid potting material and encloses the first electrical connection portion, the second electrical connection portion, and the circuit protection component, the accommodation component has a recess that is formed by recessing an installation surface of the fuse unit and in which the first electrical connection portion, the second electrical connection portion, the circuit protection component, and the coating resin portion are accommodated, and the coating resin portion is formed in close contact with a bottom surface of the recess.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a conductive module according to an embodiment;

FIG. 2 is a schematic diagram illustrating a battery module together with a connection conductor;

FIG. 3 is a perspective view illustrating a fuse unit (excluding a coating resin portion) according to the embodiment;

FIG. 4 is a perspective view for describing a pair of standing walls of the embodiment;

FIG. 5 is a perspective view illustrating a fuse unit (excluding a coating resin portion) according to a first modification example;

FIG. 6 is a perspective view for describing a recess according to the first modification example;

FIG. 7 is a cross-sectional view taken along line X-X in FIG. 6;

FIG. 8 is a perspective view illustrating a fuse unit (excluding a coating resin portion) according to a second modification example;

FIG. 9 is a perspective view for describing a recess of the second modification example; and

FIG. 10 is a cross-sectional view taken along line X-X in FIG. 9.

### DETAILED DESCRIPTION OF THE PREFERRED EMBODIMENTS

Hereinafter, embodiments of a conductive module according to the present invention will be described in detail with reference to the drawings. Note that the present invention is not limited by the embodiment.

### Embodiment

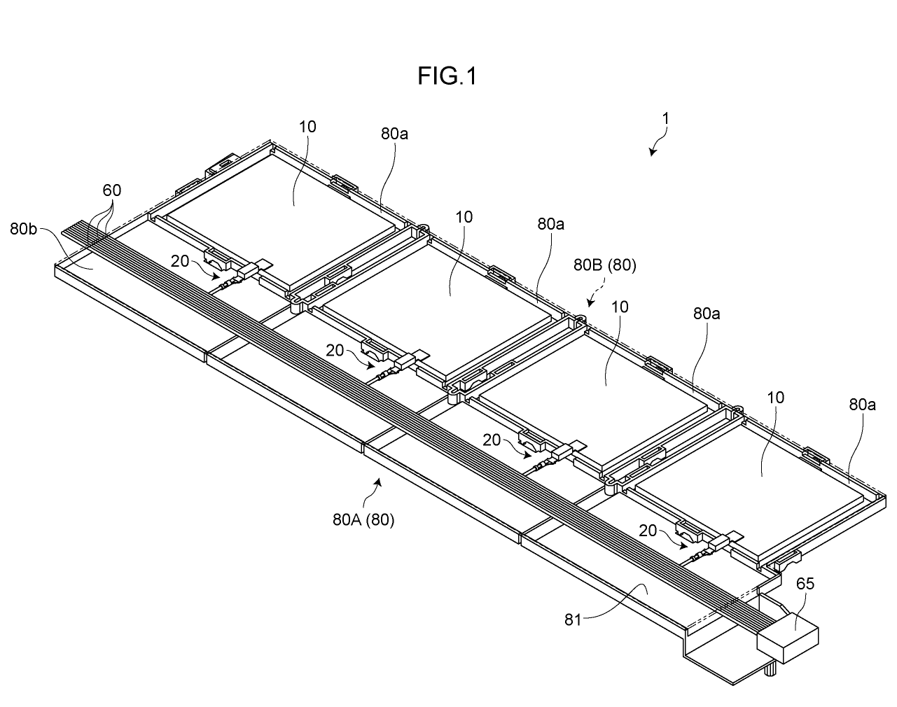

One of embodiments of a conductive module according to the present invention will be described with reference to FIGS. 1 to 4.

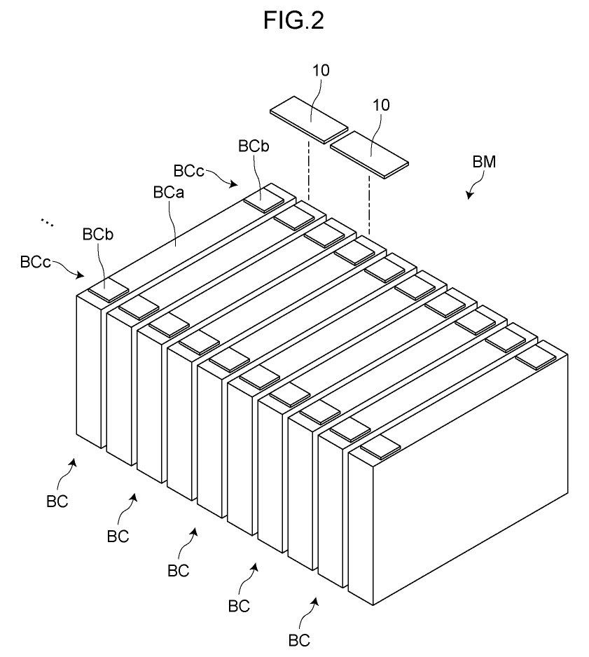

The reference numeral 1 in FIG. 1 denotes a conductive module of the present embodiment. The conductive module 1 is assembled to a battery module BM (FIG. 2) in which a plurality of battery cells BC are arranged in the arrangement direction, and electrically connects the plurality of battery cells BC in the battery module BM. The conductive module 1 electrically connects the battery module BM to a battery monitoring unit (not illustrated) to cause the battery monitoring unit to monitor a battery state of the battery cell BC. The conductive module 1 configures a battery pack together with the battery module BM. The battery pack is mounted on, for example, a vehicle (BEV: Battery Electric Vehicle, HEV: Hybrid Electric Vehicle, etc.) including a rotary machine as a drive source, and is used for supplying power to the rotary machine.

The battery cell BC includes a cell body BCa and positive and negative electrode terminals BCb (FIG. 2). In the battery module BM, a plurality of the battery cells BC are arranged in a row in the arrangement direction. The battery module BM includes one electrode terminal group BCc in which one electrode terminals BCb of the plurality of battery cells BC are arranged in the arrangement direction, and the other electrode terminal group BCc in which the other electrode terminals BCb of the plurality of battery cells BC are arranged in the arrangement direction (FIG. 2).

Hereinafter, in a case where the term "arrangement direction" is not particularly mentioned, it refers to the arrangement direction of the plurality of battery cells BC and the arrangement direction of the plurality of electrode terminals BCb in the electrode terminal group BCc.

In the battery cell BC described here, the cell body BCa is formed in a cubic shape having six outer wall surfaces. In the plurality of battery cells BC, cell bodies BCa adjacent to each other in the arrangement direction are disposed to face each other with one outer wall surface therebetween. For example, in the battery cell BC, the positive and negative electrode terminals BCb are disposed in one of the six outer wall surfaces of the cell body BCa or in two of the six outer wall surfaces of the cell body BCa. In this example, each battery cell BC includes positive and negative electrode terminals BCb on one of the six outer wall surfaces of the cell body BCa (FIG. 2). Therefore, in the battery module BM, two electrode terminal groups BCc are provided on one plane (FIG. 2).

The electrode terminal BCb described here is molded in a flat plate shape, and a connection conductor 10 that will be described later is directly electrically connected through laser welding or the like (FIG. 2). However, the electrode terminal BCb may be formed in a pole shape having a male screw portion. In this case, the connection conductor 10 is screwed and fixed to the electrode terminal BCb by screwing a female screw member to the male screw portion of the electrode terminal BCb.

The conductive module 1 includes the connection conductor 10 directly electrically connected to the electrode terminal BCb of the battery cell BC configuring the battery module BM (FIGS. 1 and 2).

The connection conductor 10 is molded by using a metal material. The connection conductor 10 is a metal plate-shaped conductive component called a bus bar, and is press-molded by using a metal plate as a base material, for example. The connection conductor 10 described here is molded in a rectangular flat plate shape.

The conductive module 1 includes, as the connection conductor 10, for example, one that is directly electrically connected to the electrode terminal BCb adjacent to the pair of battery cells BC in the battery module BM, one that is directly electrically connected to the electrode terminal BCb serving as an overall negative electrode in the battery module BM, and one that is directly electrically connected to the electrode terminal BCb serving as an overall positive electrode in the battery module BM.

The conductive module 1 includes a fuse unit 20 that indirectly electrically connects the connection conductor 10 to the battery monitoring unit (FIGS. 1, 3, and 4). The fuse unit 20 indirectly electrically connects the connection conductor 10 and the battery monitoring unit, and interrupts energization when an overcurrent flows therebetween. The fuse unit 20 is provided for each connection conductor 10.

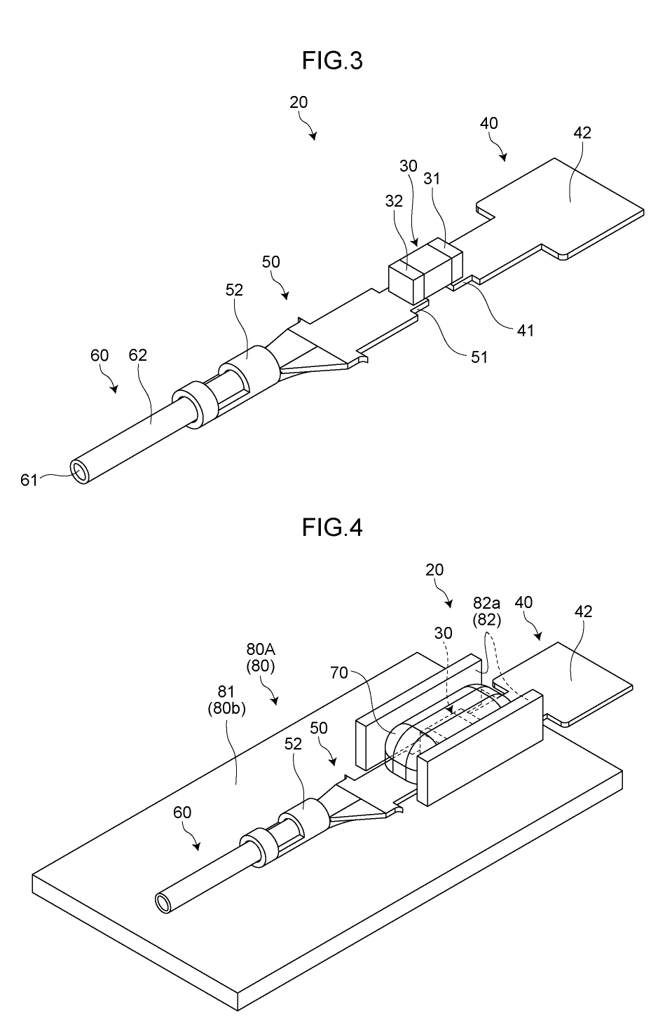

The fuse unit 20 includes a circuit protection component 30 that fuses a fusible portion when an overcurrent flows between the connection conductor 10 and the battery monitoring unit (FIGS. 3 and 4). The circuit protection component 30 includes a first electrode 31 and a second electrode 32 disposed with the fusible portion interposed therebetween (FIG. 3). The first electrode 31 and the second electrode 32 are disposed on a straight line by being divided into one end and the other end of the circuit protection component 30.

The circuit protection component 30 may be configured as, for example, a chip fuse having a fusible portion, or may be configured as a pattern fuse in which a wiring pattern having a fusible portion is provided on a printed circuit board (for example, a flexible printed circuit board). The circuit protection component 30 described here is configured as a cubic chip fuse. The first electrode 31 is provided over five outer wall surfaces at one end of the circuit protection component 30. The second electrode 32 is provided over five outer wall surfaces at the other end of the circuit protection component 30.

The fuse unit 20 includes a first terminal fitting 40 and a second terminal fitting 50 which are directly electrically connected to the circuit protection component 30 (FIGS. 3 and 4). The first terminal fitting 40 and the second terminal fitting 50 are molded by using a conductive material such as metal. For example, the first terminal fitting 40 and the second terminal fitting 50 are press-molded by using a metal plate as a base material.

The first terminal fitting 40 includes a first electrical connection portion 41 that is directly electrically connected to the first electrode 31 of the circuit protection component 30 (FIG. 3). One of four outer wall surfaces of the first electrode 31 arranged in the circumferential direction is placed on the first electrical connection portion 41, and the first electrode 31 is directly electrically connected through laser welding, soldering, or the like. Therefore, the first electrical connection portion 41 is formed in a flat plate shape provided with a plane on which the outer wall surface of the first electrode 31 is placed. In the first electrical connection portion 41, the plane and the first electrode 31 are directly electrically connected (FIG. 3).

Furthermore, the first terminal fitting 40 includes a conductor connection portion 42 directly or indirectly electrically connected to the connection conductor 10 (FIGS. 3 and 4). The conductor connection portion 42 is formed in a flat plate shape, and is placed on the connection conductor 10 with flat surfaces overlapping each other. The conductor connection portion 42 is directly electrically connected to the connection conductor 10 through laser welding, ultrasonic bonding, or the like. The conductor connection portion 42 described here is formed in a rectangular flat plate shape.

The first terminal fitting 40 described here is molded in a single flat plate shape in which the first electrical connection portion 41 and the conductor connection portion 42 are adjacent to each other.

The second terminal fitting 50 includes a second electrical connection portion 51 directly electrically connected to the second electrode 32 of the circuit protection component 30 (FIG. 3). One of four outer wall surfaces of the second electrode 32 arranged in the peripheral direction is placed on the second electrical connection portion 51, and the second electrode 32 is directly electrically connected through laser welding, soldering, or the like. Therefore, the second electrical connection portion 51 is formed in a flat plate shape provided with a plane on which the outer wall surface of the second electrode 32 is placed. In the second electrical connection portion 51, the plane and the second electrode 32 are directly electrically connected (FIG. 3).

Further, the second terminal fitting 50 is indirectly electrically connected to the battery monitoring unit. The fuse unit 20 includes a wiring component 60 interposed between the second terminal fitting 50 and the battery monitoring unit (FIGS. 1, 3, and 4), and indirectly electrically connects the second terminal fitting 50 to the battery monitoring unit via the wiring component 60.

The wiring component 60 includes a conductor portion 61 having one end directly electrically connected to the second terminal fitting 50 and the other end indirectly electrically connected to the battery monitoring unit (FIG. 3). The wiring component 60 includes an insulating coating 62 that has an electrical insulating property and covers the conductor portion 61 (FIG. 3).

Specifically, the conductor portion 61 described here is formed in a linear shape. The wiring component 60 described here is an electric wire in which a core wire as the linear conductor portion 61 is covered with an insulating coating 62 having electrical insulating property, and directly electrically connects the second terminal fitting 50 to one end of the conductor portion 61 at the terminal end thereof. The second terminal fitting 50 has a wiring connection portion 52 directly electrically connected to the conductor portion 61 of the wiring component 60 (FIGS. 3 and 4).

For example, in the wiring component 60, the insulating coating 62 is peeled off at the terminal to expose one end of the conductor portion 61. In this case, as the wiring connection portion 52, a wiring connection portion formed as a caulking crimp portion in which one end of the conductor portion 61 (that is, the core wire of the end of the electric wire) is placed on a bottom portion and caulked and crimped to the one end of the conductor portion 61 between the bottom portion and a barrel piece portion may be applied. In addition, for example, as the wiring component 60, a wiring component in which the terminal end of the conductor portion 61 is covered with the insulating coating 62 may be used. In this case, as the wiring connection portion 52, a wiring connection portion formed as a pair of pressure contact blades that make a cut in the insulating coating 62 at the terminal end of the wiring component 60 and sandwich one end of the conductor portion 61 (the core wire of the end of the electric wire) may be applied. The wiring connection portion 52 described here is formed as a caulking crimp portion.

In the second terminal fitting 50 described here, the second electrical connection portion 51 and the wiring connection portion 52 are adjacent to each other, and the bottom portion of the wiring connection portion 52 is disposed on the same plane as the flat plate-shaped second electrical connection portion 51. The wiring connection portion 52 causes the wiring component 60 to be drawn out in the adjacent direction along the plane of the second electrical connection portion 51.

Note that the wiring component 60 may be a flat routing member such as a flexible printed circuit board in which the conductor portion 61 is formed as a wiring pattern (not illustrated). In this case, in the wiring component 60, the conductor portion 61 for each of the second terminal fittings 50 in the plurality of fuse units 20 is formed, and one end of the conductor portion 61 is provided at a terminal end of a branch portion branched from the main body for each of the second terminal fittings 50. One end of the conductor portion 61 is directly electrically connected to, for example, the wiring connection portion 52 through laser welding, soldering, or the like.

The fuse unit 20 includes an electrically insulating coating resin portion 70 enclosing the first electrical connection portion 41, the second electrical connection portion 51, and the circuit protection component 30 (FIG. 4). The coating resin portion 70 encloses the first electrical connection portion 41, the second electrical connection portion 51, and the circuit protection component 30 to suppress energization between the first electrical connection portion 41 and the second electrical connection portion 51. The coating resin portion 70 can suppress, for example, a short circuit between the first electrical connection portion 41 and the second electrical connection portion 51 due to dew condensation water. For example, the coating resin portion 70 is a cured body of a liquid resin material (so-called ultraviolet curable or thermosetting potting material) that is supplied through dropping or the like to enclose the first electrical connection portion 41, the second electrical connection portion 51, and the circuit protection component 30.

The conductive module 1 of the present embodiment is assembled to the battery module BM and includes an accommodation component (hereinafter, referred to as a "module accommodation component") 80 in which the connection conductor 10 and the fuse unit 20 are accommodated (FIG. 1).

The module accommodation component 80 is provided with an accommodation chamber (hereinafter, referred to as a "conductor accommodation chamber") 80a that accommodates the connection conductor 10 and an accommodation chamber (hereinafter referred to as an "unit accommodation chamber") 80b that accommodates the fuse unit 20 (FIG. 1). For example, the module accommodation component 80 includes the conductor accommodation chamber 80a for each of the connection conductors 10 connected to the respective electrode terminals BCb of the electrode terminal group BCc. On the other hand, the module accommodation component 80 includes the unit accommodation chamber 80b in which the fuse units 20 for the respective connection conductors 10 are collectively accommodated.

In the unit accommodation chamber 80b, the fuse unit 20 is installed on a wall surface (hereinafter, referred to as an "installation surface") 81 of a bottom wall disposed between the fuse unit 20 and the battery cell BC (FIGS. 1 and 4). The fuse unit 20 is installed to face the bottom of the wiring connection portion 52 on the installation surface 81.

In the unit accommodation chamber 80b, the wiring component 60 (electric wire) of each fuse unit 20 is routed to the battery monitoring unit side. In each wiring component 60 (electric wire), the other end of the ends routed to the battery monitoring unit side is coupled to a connector 65 (FIG. 1). Each wiring component 60 (electric wire) is indirectly electrically connected to the battery monitoring unit via the connector 65.

In a case where the wiring component 60 is a flat routing member, the unit accommodation chamber 80b accommodates the wiring component 60 (flat routing member) having the conductor portion 61 connected to the second terminal fitting 50 of each fuse unit 20 (not illustrated).

The module accommodation component 80 has, as a part thereof, a pair of standing walls 82 that protrude from the installation surface 81 of the fuse unit 20 with a gap therebetween and allow the first electrical connection portion 41, the second electrical connection portion 51, the circuit protection component 30, and the coating resin portion 70 to be disposed in the gap (FIG. 4). The pair of standing walls 82 is formed together during molding of the module accommodation component 80. The pair of standing walls 82 described here are formed in a rectangular flat plate shape with flat surfaces (hereinafter, "facing wall surfaces") 82a facing each other (FIG. 4).

Here, the coating resin portion 70 is made by using a liquid potting material having a viscosity capable of holding the liquid potting material until the potting material is cured so that the liquid potting material does not flow to the surroundings before being cured, the potting material being supplied to enclose the first electrical connection portion 41, the second electrical connection portion 51, and the circuit protection component 30. However, even if the liquid potting material has such properties, fluidity is not lost, and thus the pair of standing walls 82 function as locking walls for stopping the flow of the liquid potting material. Therefore, the coating resin portion 70 is in close contact with the installation surface 81 of the fuse unit 20 and the facing wall surfaces 82a of the pair of standing walls 82, and is formed between one standing wall 82 and the other standing wall 82.

For example, the module accommodation component 80 includes a first accommodation member (hereinafter, referred to as a "first module accommodation member") 80A and a second accommodation member (hereinafter, referred to as a "second module accommodation member") 80B that are assembled and fixed to each other (FIG. 1). The first module accommodation member 80A and the second module accommodation member 80B are molded by using an electrically insulating material such as synthetic resin.

The first module accommodation member 80A is provided with a space portion for forming the plurality of conductor accommodation chambers 80a and the unit accommodation chamber 80b at the assembly completion position with the second module accommodation member 80B. The first module accommodation member 80A is provided with a pair of standing walls 82 for each fuse unit 20. The second module accommodation member 80B is molded as a cover member that covers an opening of each space portion of the first module accommodation member 80A.

As described above, in the conductive module 1 of the present embodiment, by providing the pair of standing walls 82 as a part of the module accommodation component 80, it is possible to stop the flow of the liquid potting material to the surroundings of the fuse unit 20 without preparing a component for stopping the flow of the liquid potting material separately from the module accommodation component and the like as in the related art. Therefore, in the conductive module 1 of the present embodiment, the coating resin portion 70 can be inexpensively made of a liquid potting material.

### First modification example

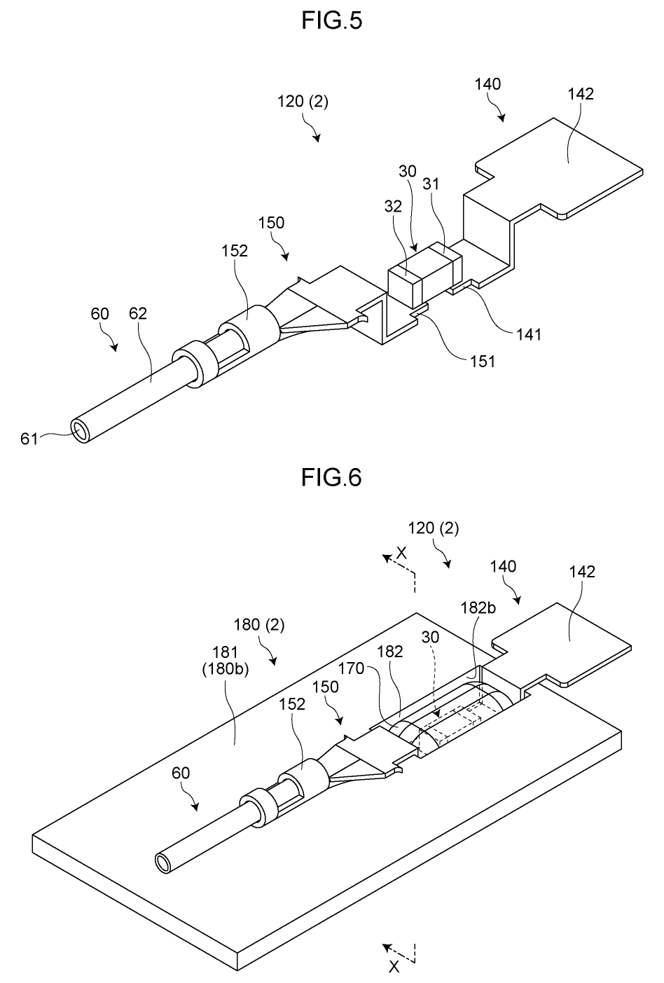

A conductive module 2 of the present modification example corresponds to the conductive module 1 of the above-described embodiment in which the fuse unit 20 is replaced with the following fuse unit 120 and the module accommodation component 80 is replaced with the following module accommodation component 180 (FIGS. 5 to 7).

The fuse unit 120 of the present modification example corresponds to the fuse unit 20 of the embodiment in which the first terminal fitting 40 and the second terminal fitting 50 are replaced with the following first terminal fitting 140 and second terminal fitting 150, and the coating resin portion 70 is replaced with the following coating resin portion 170 accordingly (FIGS. 5 to 7).

Similarly to the first terminal fitting 40 of the embodiment, a first terminal fitting 140 includes a flat plate-shaped first electrical connection portion 141 and a flat plate-shaped conductor connection portion 142 (FIGS. 5 to 7). However, the first terminal fitting 140 is molded in a flat plate crank shape in which the direction orthogonal to the plane of the first electrical connection portion 141 and the conductor connection portion 142 is a vertical direction, and the conductor connection portion 142 is disposed vertically below the first electrical connection portion 141.

Similarly to the second terminal fitting 50 of the embodiment, the second terminal fitting 150 includes a second electrical connection portion 151 having a flat plate shape and a wiring connection portion 152 (FIGS. 5 to 7). However, the second terminal fitting 150 has a crank shape in which the direction orthogonal to the plane of the second electrical connection portion 151 is a vertical direction, and the second electrical connection portion 151 is disposed vertically below the wiring connection portion 152.

Similarly to the coating resin portion 70 of the embodiment, the coating resin portion 170 is a cured body of a liquid resin material (so-called ultraviolet curable or thermosetting potting material) that is supplied through dropping or the like to enclose the first electrical connection portion 141, the second electrical connection portion 151, and the circuit protection component 30.

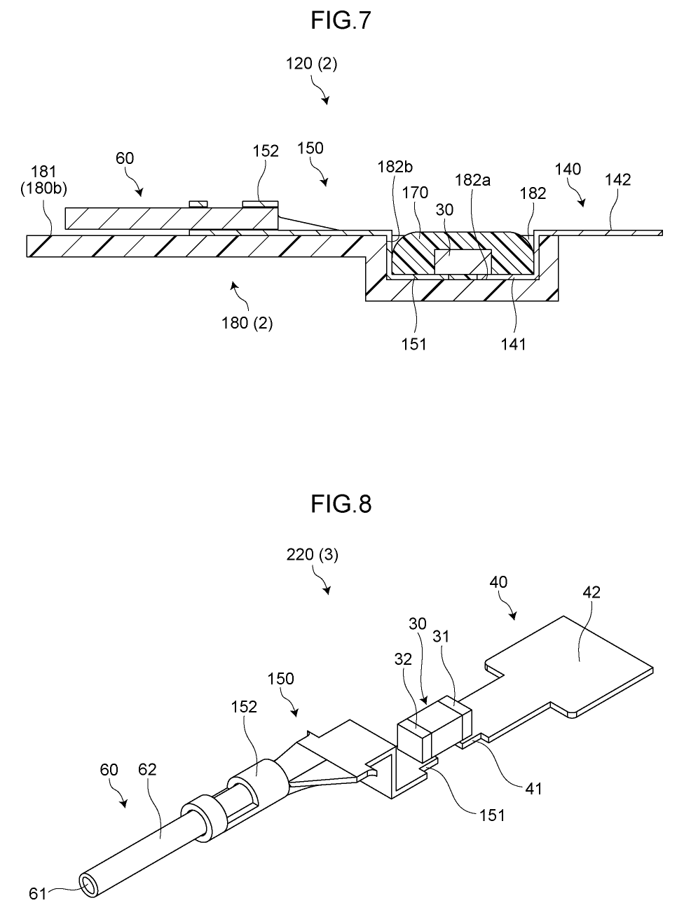

Similarly to the module accommodation component 80 of the embodiment, the module accommodation component 180 of the present modification example is provided with a unit accommodation chamber 180b having an installation surface 181 of the fuse unit 120 (FIGS. 6 and 7). However, the module accommodation component 180 has a recess 182 that is formed by recessing the installation surface 181 of the fuse unit 120 and in which the first electrical connection portion 141, the second electrical connection portion 151, the circuit protection component 30, and the coating resin portion 170 are accommodated (FIGS. 6 and 7). The coating resin portion 170 is formed in close contact with a bottom surface 182a of the recess 182 (FIG. 7).

The recess 182 has a peripheral wall 182b surrounding the first electrical connection portion 141, the second electrical connection portion 151, the circuit protection component 30, and the coating resin portion 170 from four sides (FIGS. 6 and 7). Therefore, as the liquid potting material forming the coating resin portion 170, a potting material having a viscosity that allows the potting material to flow to the surroundings before being cured after being supplied to enclose the first electrical connection portion 141, the second electrical connection portion 151, and the circuit protection component 30 may be used. In this case, for example, the coating resin portion 170 after being cured encloses the first electrical connection portion 141, the second electrical connection portion 151, and the circuit protection component 30 by filling the recess 182 with the liquid potting material. The recess 182 described here is formed as a cubic recess. Similarly to the coating resin portion 70 of the embodiment, a liquid potting material may be used, which has a viscosity capable of holding the potting material while enclosing the first electrical connection portion 141, the second electrical connection portion 151, and the circuit protection component 30 until being cured.

In the conductive module 2 of the present modification example, by providing the recess 182 as a part of the module accommodation component 180, it is possible to stop the flow of the liquid potting material to the surroundings of the fuse unit 120 without preparing a component for stopping the flow of the liquid potting material separately from the module accommodation component and the like as in the related art. Further, in the conductive module 2 of the present modification example, compared with the conductive module 1 of the embodiment, since the liquid potting material can be held in the recess 182 regardless of the viscosity thereof, the flow of the liquid potting material to the surroundings of the fuse unit 120 can be more reliably stopped. Therefore, in the conductive module 2 of the present modification example, the coating resin portion 170 can be inexpensively made of a liquid potting material.

### Second modification example

A conductive module 3 of the present modification example corresponds to the conductive module 2 of the first modification example in which the fuse unit 120 is replaced with the following fuse unit 220 and the module accommodation component 180 is replaced with the following module accommodation component 280 (FIGS. 8 to 10).

The fuse unit 220 of the present modification example corresponds to the fuse unit 120 of the first modification example in which the first terminal fitting 140 is replaced with the first terminal fitting 40 of the above-described embodiment, and the coating resin portion 70 is replaced with the following coating resin portion 270 accordingly (FIGS. 8 to 10).

Similarly to the coating resin portion 170 of the first modification example, the coating resin portion 270 is a cured body of a liquid resin material (so-called ultraviolet curable or thermosetting potting material) that is supplied through dropping or the like to enclose the first electrical connection portion 41, the second electrical connection portion 151, and the circuit protection component 30.

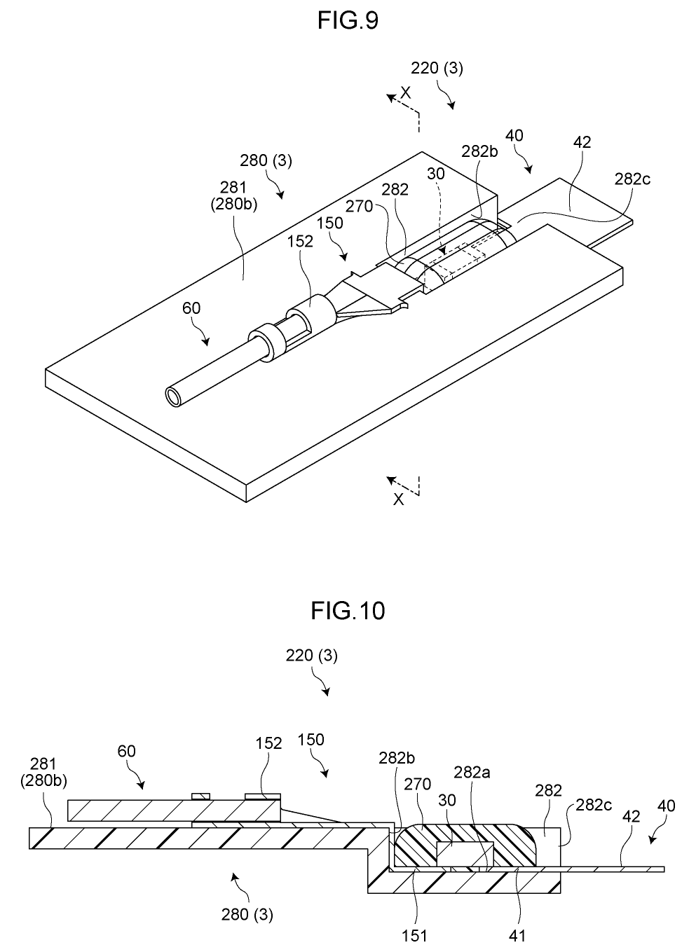

Similarly to the module accommodation component 180 of the first modification example, the module accommodation component 280 of the present modification example is provided with a unit accommodation chamber 280b having an installation surface 281 of the fuse unit 220 (FIGS. 9 and 10). The module accommodation component 280 has a recess 282 that is formed by recessing the installation surface 281 of the fuse unit 220 and in which the first electrical connection portion 41, the second electrical connection portion 151, the circuit protection component 30, and the coating resin portion 270 are accommodated (FIGS. 9 and 10). The coating resin portion 270 is formed in close contact with a bottom surface 282a of the recess 282 (FIG. 10).

However, in the recess 282 of the present modification example, an opening 282c through which the first terminal fitting 40 is drawn out of the recess 282 is provided in the peripheral wall 282b in the recess 182 of the first modification example (FIGS. 9 and 10). The recess 282 described here is formed as a cubic recess, and the opening 282c is formed by removing the wall of the peripheral wall 282b on the first terminal fitting 40 side. Therefore, similarly to the coating resin portion 70 of the embodiment, a liquid potting material that forms the coating resin portion 270 is used, which has a viscosity capable of holding the potting material while enclosing the first electrical connection portion 41, the second electrical connection portion 151, and the circuit protection component 30 until being cured.

In the conductive module 3 of the present modification example, similarly to the conductive module 2 of the first modification example, by providing the recess 282 as a part of the module accommodation component 280, it is possible to stop the flow of the liquid potting material around the fuse unit 220 without preparing a component for stopping the flow of the liquid potting material separately from the module accommodation component and the like as in the related art. Therefore, in the conductive module 3 of the present modification example, the coating resin portion 270 can be inexpensively made of a liquid potting material.

The conductive module according to the present embodiment can stop the flow of the liquid potting material to the surroundings of the fuse unit without preparing a component for stopping the flow of the liquid potting material separately from the accommodation component or the like as in the related art by providing a pair of standing walls or a recess as a part of the accommodation component. Therefore, in the conductive module according to the present embodiment, the coating resin portion can be inexpensively made of a liquid potting material.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
a connection conductor that is directly electrically connected to an electrode terminal of a battery cell configuring a battery module;
a fuse unit that indirectly electrically connects the connection conductor to a battery monitoring unit that monitors a battery state of the battery cell; and
an accommodation component that is assembled to the battery module and in which the connection conductor and the fuse unit are accommodated, wherein
the fuse unit includes
a circuit protection component that fuses a fusible portion when an overcurrent flows between the connection conductor and the battery monitoring unit,
a first terminal fitting that directly electrically connects a first electrical connection portion to a first electrode of the circuit protection component, and directly or indirectly electrically connects a conductor connection portion to the connection conductor,
a second terminal fitting that directly electrically connects a second electrical connection portion to a second electrode of the circuit protection component and indirectly electrically connects the second electrical connection portion to the battery monitoring unit,
a wiring component including a conductor portion having one end directly electrically connected to the second terminal fitting and the other end electrically connected indirectly to the battery monitoring unit, and
a coating resin portion that is a cured body of a liquid potting material and encloses the first electrical connection portion, the second electrical connection portion, and the circuit protection component,
the accommodation component includes a pair of standing walls that protrude from an installation surface of the fuse unit with a gap therebetween as a part of the accommodation component and allow the first electrical connection portion, the second electrical connection portion, the circuit protection component, and the coating resin portion to be disposed in the gap, and
the coating resin portion is in close contact with the installation surface and facing wall surfaces of the pair of standing walls, and is formed between one standing wall and the other standing wall.

2. The conductive module according to claim 1, wherein
the pair of standing walls function as locking walls for stopping a flow of the liquid potting material.

3. A conductive module comprising:
a connection conductor that is directly electrically connected to an electrode terminal of a battery cell configuring a battery module;
a fuse unit that indirectly electrically connects the connection conductor to a battery monitoring unit that monitors a battery state of the battery cell; and
an accommodation component that is assembled to the battery module and in which the connection conductor and the fuse unit are accommodated, wherein
the fuse unit includes
a circuit protection component that fuses a fusible portion when an overcurrent flows between the connection conductor and the battery monitoring unit,
a first terminal fitting that directly electrically connects a first electrical connection portion to a first electrode of the circuit protection component, and directly or indirectly electrically connects a conductor connection portion to the connection conductor,
a second terminal fitting that directly electrically connects a second electrical connection portion to a second electrode of the circuit protection component and indirectly electrically connects the second electrical connection portion to the battery monitoring unit,
a wiring component including a conductor portion having one end directly electrically connected to the second terminal fitting and the other end electrically connected indirectly to the battery monitoring unit, and
a coating resin portion that is a cured body of a liquid potting material and encloses the first electrical connection portion, the second electrical connection portion, and the circuit protection component,
the accommodation component has a recess that is formed by recessing an installation surface of the fuse unit and in which the first electrical connection portion, the second electrical connection portion, the circuit protection component, and the coating resin portion are accommodated, and
the coating resin portion is formed in close contact with a bottom surface of the recess.

4. The conductive module according to claim 3, wherein
the recess includes a peripheral wall surrounding the first electrical connection portion, the second electrical connection portion, the circuit protection component, and the coating resin portion from four sides.

5. The conductive module according to claim 4, wherein
the peripheral wall is provided with an opening through which the first terminal fitting is drawn out of the recess.
